(19) United States
(12) Patent Application Publication
(10) Pub. No.: US 2022/0205828 A1
(43) Pub. Date: Jun. 30, 2022

(54) NOVEL MECHANICAL PLATFORM SCALE

(71) Applicant: Nanning Weighing Apparatus Factory, Nanning City (CN)

(72) Inventor: Cheng Qin, Nanning City (CN)

(21) Appl. No.: 17/169,141

(22) Filed: Feb. 5, 2021

(30) Foreign Application Priority Data
Dec. 29, 2020 (CN) 202023242405.6

(51) Int. Cl. G01G 1/24; G01G 19/08; G01G 21/26

(52) U.S. Cl. CPC G01G 1/24; G01G 21/26; G01G 19/08

(57) ABSTRACT

Disclosed is a novel mechanical platform scale, including: a platform scale body, wherein a first wheel and a second wheel are arranged at the top of the other side end of the platform scale body at an interval; an upright column arranged at one side end of the platform scale body; an adjustment mechanism arranged at the top end of the upright column; and a pull rod rotatably arranged in one side end of the platform scale body, wherein the top end of the pull rod is provided with a pull handle ring. One side end of the platform scale body extends to be provided with an extending plate, and the pull rod is rotatably arranged in the extending plate; a wheel mechanism is arranged in the extending plate; and a clamping mechanism used for clamping the pull rod in the upright column is arranged in the upright column. By the above mode, the mechanical platform scale disclosed by the present disclosure can be pulled by means of the pull rod to move, and is convenient to carry, so that the user experience is greatly enhanced.

### TECHNICAL FIELD

The present disclosure relates to the technical field of mechanical platform scales, and in particular, a novel mechanical platform scale.

### BACKGROUND

A mechanical platform scale works with an unequal arm lever principle, which has weighing accuracy and convenience in use, and are still used as main weighing instruments in many factories, shops, schools, warehouses and other enterprises and institutions.

At the present, mechanical platform scales on the market are relatively heavy and cumbersome to move, which is not conducive to carrying and greatly reduces the user experience.

### SUMMARY

The technical problem mainly solved by the present disclosure is to provide a novel mechanical platform scale. The mechanical platform scale can be pulled by a pull rod to move, and is convenient to carry, so that the user experience is greatly enhanced.

In order to solve the above technical problem, one technical solution adopted by the present disclosure is: Provided is a novel mechanical platform scale, including a platform scale body, an upright column arranged at one side end of the platform scale body, and an adjustment mechanism arranged at the top end of the upright column. A first wheel and a second wheel are arranged at the top of the other side end of the platform scale body at an interval. The novel mechanical platform scale is characterized by further including: a pull rod rotatably arranged in one side end of the platform scale body, and the top end of the pull rod is provided with a pull handle ring. One side end of the platform scale body extends to be provided with an extending plate; the pull rod is rotatably arranged in the extending plate; a wheel mechanism is arranged in the extending plate; and a clamping mechanism used for clamping the pull rod in the vertical rod is arranged in the vertical rod.

Further, the adjustment mechanism is provided with a rectangularly planar top plate; the top plate is provided with a long-strip open slot disposed along a lengthwise direction, and the long-strip open slot is arranged on one side edge of the top plate to cause one side edge of the top plate to form a supporting rod used for supporting a weight.

Further, the platform scale body includes a scale body supporting plate used for weighing and a supporting framework arranged outside the scale body supporting plate; the scale body supporting plate is planar, and a horizontal plane where the scale body supporting plate is located is the same as a horizontal plane where a top surface of the supporting framework is located.

Further, one side surface of the other side end of the upright column away from the platform scale body is provided, along the lengthwise direction, with an accommodating groove used for accommodating the pull rod.

Further, the clamping mechanism includes a first fixed rod arranged on one side of the accommodating groove of the upright column, a second fixed rod arranged on the other side of the accommodating groove of the upright column, and a clamping rod with one end rotatably arranged in the first fixed rod. A clamping slot used for accommodating the other end of the clamping rod is formed in the second fixed rod.

Further, the wheel mechanism includes a connection rod arranged in the extending plate in a penetrating manner, a connection frame arranged at the bottom of the connection rod, and a third wheel rotatably arranged in the connection frame. The top end of the connection rod is rotatably connected with the bottom end of the pull rod.

Further, the bottom end of the pull rod is provided with a first protruding rod and a second protruding rod at an interval; the first protruding rod is provided with a first through hole, and the second protruding rod is provided with a second through hole corresponding to the first through hole; the top end of the connection rod is provided with a third through hole corresponding to the first through hole; and first screws are arranged in the first through hole, the third through hole and the second through hole in a penetrating manner.

Further, the wheel mechanism further includes a first fixed plate arranged on the top surface of the extending plate, and a second fixed plate arranged on a bottom surface of the extending plate. The extending plate is provided with a first penetrating hole, and the first fixed plate is provided with a second penetrating hole corresponding to the first penetrating hole; the second fixed plate is provided with a third penetrating hole corresponding to the first penetrating hole; the connection rod is arranged in the second penetrating hole, the first penetrating hole and the third penetrating hole in a penetrating manner; and an end of the second fixed plate facing the connection frame is provided with a first accommodating blind hole communicating with the third penetrating hole. A buffer spring is arranged in the first accommodating blind hole, and the connection rod is arranged in the buffer spring in a penetrating manner.

Further, an aperture of the first accommodating blind hole is greater than the aperture of the third penetrating hole. A depth of the first accommodating blind hole is less than a length of the buffer spring in a normal state; an end of the first fixed plate facing the second fixed plate is provided with a second accommodating blind hole communicating with the second penetrating hole; the second accommodating blind hole is provided with a bearing; and the connection rod is arranged in an inner ring of the bearing in a penetrating manner.

Further, two sides of the first fixed plate respectively extend to be provided with a first fixed block and a second fixed block, and the first fixed block and the second fixed block are arranged on the top surface of the extending plate in a screw fastening manner; two sides of the second fixed plate respectively extend to be provided with a third fixed block and a fourth fixed block, and the third fixed block and the fourth fixed block are arranged on the bottom surface of the extending plate in a screw fastening manner; and the connection frame includes a connection top plate connected to the bottom of the connection rod, and a first vertical plate and a second vertical plate which are arranged on two sides of the connection top plate. The third wheel is rotatably arranged between the first vertical plate and the second vertical plate; a first rotating rod is rotatably arranged in the first vertical plate, and a second rotating rod is rotatably arranged in the second vertical plate; and a friction strip connected to the third wheel and a pedal plate located above the friction strip are arranged between the first rotating rod and the second rotating rod.

The present disclosure has the beneficial effects that: Different from the situation of the prior art, the novel mechanical platform scale disclosed by the present disclosure includes the platform scale body, wherein the first wheel and the second wheel are arranged at the top of the other side end of the platform scale body at an interval; the upright column arranged at one side end of the platform scale body; the adjustment mechanism arranged at the top end of the upright column; and the pull rod rotatably arranged in one side end of the platform scale body, wherein the top end of the pull rod is provided with a pull handle ring. One side end of the platform scale body extends to be provided with the extending plate, and the pull rod is rotatably arranged in the extending plate; the wheel mechanism is arranged in the extending plate; and the clamping mechanism used for clamping the pull rod in the upright column is arranged in the upright column. By the above mode, the mechanical platform scale disclosed by the present disclosure can be pulled by means of the pull rod to move, and is convenient to carry, so that the user experience is greatly enhanced.

### BRIEF DESCRIPTION OF THE DRAWINGS

FIG. 1 is a schematic structural diagram of a novel mechanical platform scale of the present disclosure;

FIG. 2 is a first partially schematic structural diagram of the novel mechanical platform scale in FIG. 1;

FIG. 3 is a second partially schematic structural diagram of the novel mechanical platform scale in FIG. 1;

FIG. 4 is a third partially schematic structural diagram of the novel mechanical platform scale in FIG. 1;

FIG. 5 is a fourth partially schematic structural diagram of the novel mechanical platform scale in FIG. 1; and

FIG. 6 is a fifth partially schematic structural diagram of the novel mechanical platform scale in FIG. 1.

### DESCRIPTION OF THE EMBODIMENTS

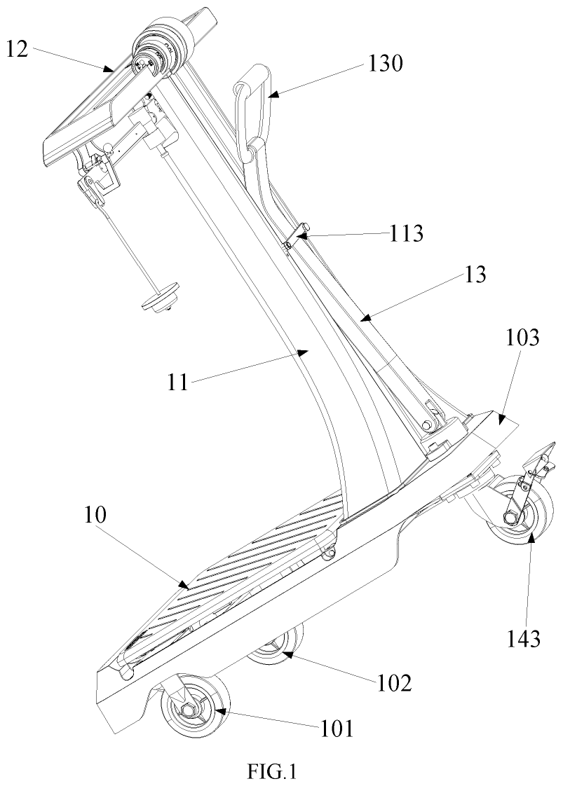

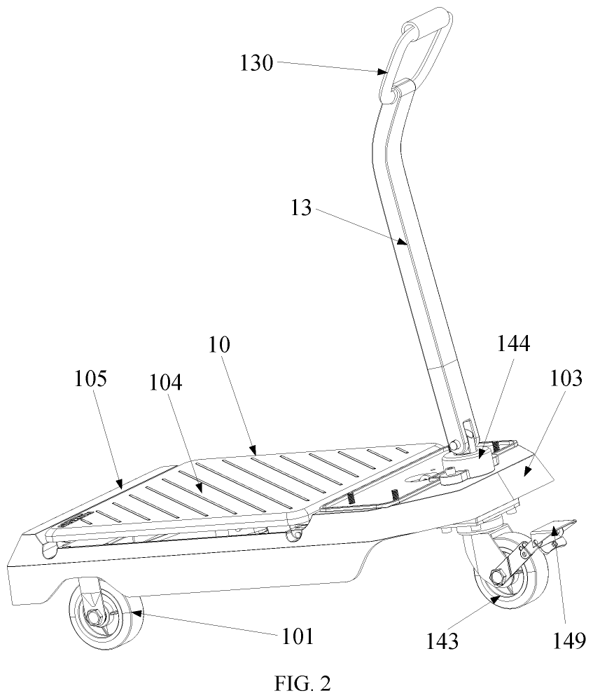

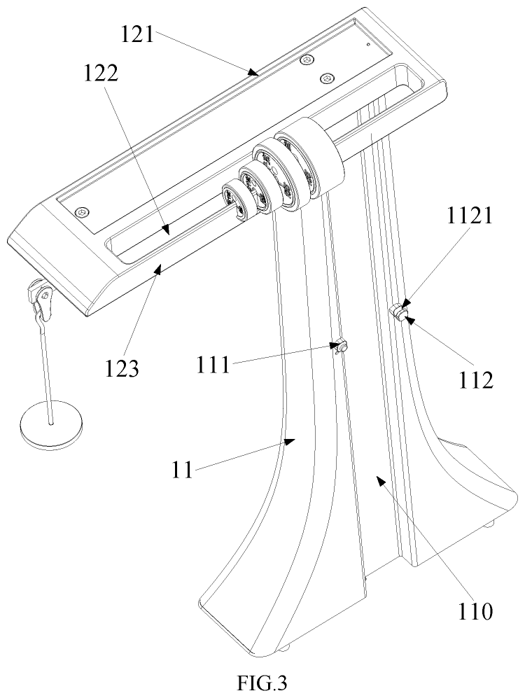

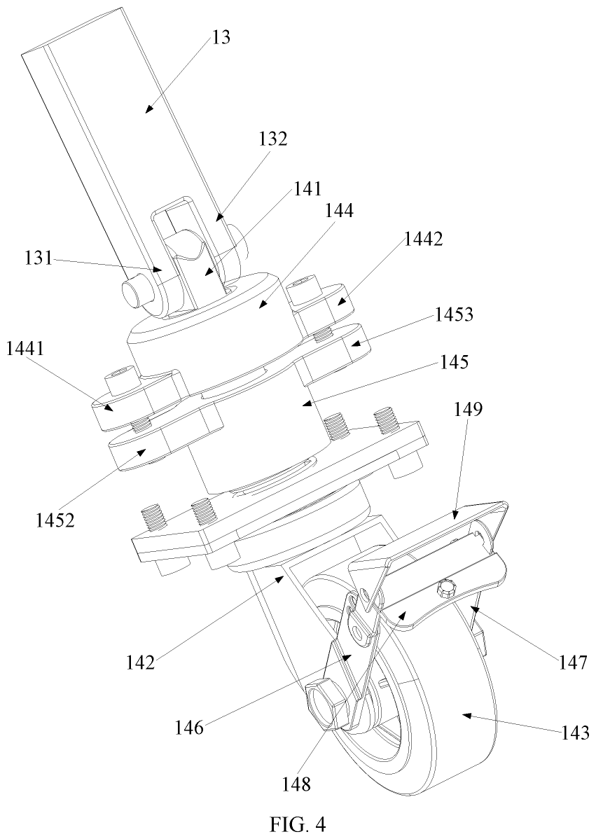

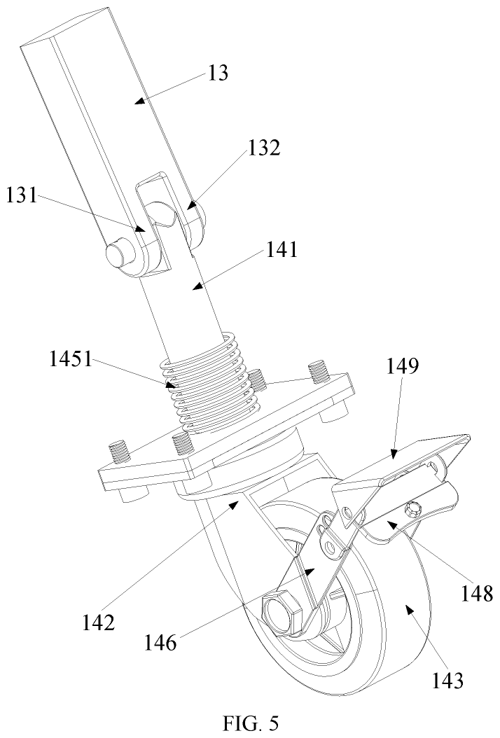

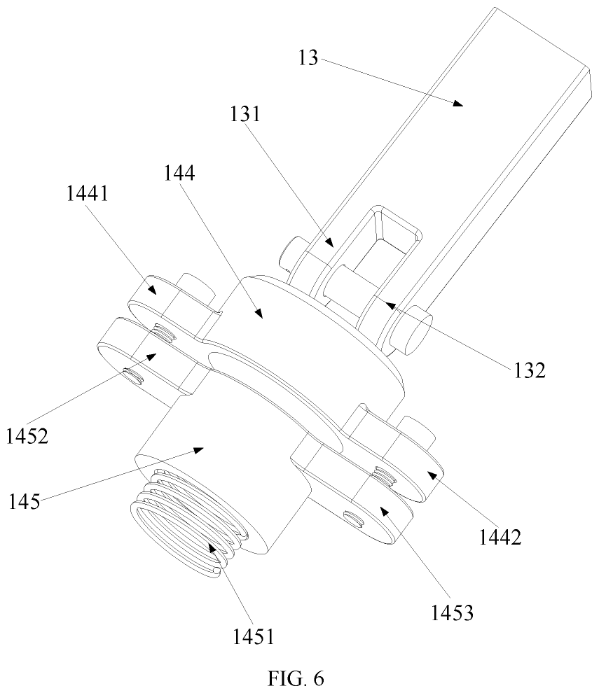

Referring to FIGS. 1 to 6, a novel mechanical platform scale includes a platform scale body 10, an upright column 11 arranged at one side end of the platform scale body 10, an adjustment mechanism 12 arranged at the top end of the upright column 11, and a pull rod 13.

In the present embodiment, a first wheel 101 and a second wheel 102 are arranged at the top of the other side end of the platform scale body 10 at an interval.

The platform scale body 10 includes a scale body supporting plate 104 used for weighing and a supporting framework 105 arranged outside the scale body supporting plate 104.

Specifically, the supporting framework 104 is provided with an accommodating space, and the scale body supporting plate 104 is accommodated in the accommodating space.

In the present embodiment, the accommodating space is rectangular, and the scale body supporting plate 104 is rectangular. Preferably, a length and a width of the scale body supporting plate 104 are slightly less than a length and a width of the accommodating space.

Further, the scale body supporting plate 104 is planar, that is, the scale body supporting plate 104 is a planar rectangle. It should be understood that the scale body supporting plate 104 is used for holding an object to be weighed.

Preferably, a horizontal plane where the scale body supporting plate 104 is located is the same as a horizontal plane where a top surface of the supporting framework 105 is located. That is, the top surface of the supporting framework 105 is also planar.

It should be understood that during normal weighing of an object, the scale body supporting plate 104 would easily damage the platform scale body 10 (a weighing structure) due to a sudden heavy stress if a relatively heavy object is directly placed in the scale body supporting plate 104. Since the horizontal plane where the scale body supporting plate 104 is located is the same as the horizontal plane where the top surface of the supporting framework 105 is located, in case of a need for weighing an object, the object can be moved into the supporting framework 105. As such, the phenomenon of easy damage to the platform scale body 10 due to the fact that the object is directly placed in the scale body supporting plate 104 can be avoided.

It is worth noting that the platform scale body 10 of the present embodiment further includes a weighing structure connected with the scale body supporting plate 104. That is, the scale body supporting plate 104 is suspended in the accommodating space by means of the weighing structure. The weighing structure may be implemented using a structure in the prior art, so the principle of the weighing structure will not be repeatedly described here.

The adjustment mechanism 12 is provided with a rectangularly planar top plate 121, and the top plate 121 is provided with a long-strip open slot 122 disposed along its lengthwise direction.

Preferably, the long-strip open slot 122 is arranged on one side edge of the top plate 121 to cause one side edge of the top plate 121 to form a supporting rod 123 used for supporting a weight. It should be understood that the weight can be clamped in the supporting rod 123 in the present embodiment. Since the top plate 121 is planar, more objects can be placed by means of the top plate 121.

Further, the other side edge of the top plate 121 is provided with a rectangular recess along its lengthwise direction, so that more objects can be accommodated by means of the recess.

It is worth mentioning that the adjustment mechanism 12 of the present embodiment further includes an adjustment structure connected with the weighing structure to realize weighing of an object by means of the scale body supporting plate 104, the weighing structure and the adjustment structure. The adjustment structure of the present embodiment can be implemented using a structure in the prior art, so it will not be repeatedly described here.

The pull rod 13 is rotatably arranged in one side end of the platform scale body 10. The top end of the pull rod 13 is provided with a pull handle ring 130, so that a person can hold the pull handle ring 130 with a hand to pull this mechanical platform scale to move.

In the present embodiment, one side surface of the other side end of the upright column 11 away from the platform scale body 10 is provided, along its lengthwise direction, with an accommodating groove 110 used for accommodating the pull rod 13.

Preferably, a clamping mechanism used for clamping the pull rod 13 in the upright column 11 is arranged in the upright column 11. That is, when the mechanical platform scale does not need to be moved, the pull rod 13 can be accommodated in the accommodating groove 110 of the upright column 11 by means of the clamping mechanism. When the mechanical platform scale needs to be moved, the pull rod 13 is taken out from the accommodating groove 110 of the upright column 11 to pull the mechanical platform scale.

In the present embodiment, the clamping mechanism includes a first fixed rod 111 arranged on one side of the accommodating groove 110 of the upright column 11, a second fixed rod 112 arranged on the other side of the accommodating groove 110 of the upright column 11, and a clamping rod 113 with one end rotatably arranged in the first fixed rod 111. A clamping slot 1121 used for accommodating the other end of the clamping rod 113 is formed in the second fixed rod 112. That is, the clamping rod 113 is rotated to cause the other end of the clamping rod 113 to be accommodated in the clamping slot 1121 when the pull rod 13 is accommodated in the accommodating groove 110 of the upright column 11, and this time, the clamping rod 113 clamps the pull rod 13.

In the present embodiment, one side end of the platform scale body 10 extends to be provided with an extending plate 103, and the pull rod 13 is rotatably arranged in the extending plate 103.

Further, a wheel mechanism is arranged in the extending plate 103, so that the mechanical platform scale can be moved by means of the wheel mechanism, the first wheel 101 and the second wheel 102.

In the present embodiment, the wheel mechanism includes a connection rod 141 arranged in the extending plate 103 in a penetrating manner, a connection frame 142 arranged at the bottom of the connection rod 141, and a third wheel 143 rotatably arranged in the connection frame 142. The top end of the connection rod 141 is rotatably connected with the bottom end of the pull rod 13.

Specifically, the connection frame includes a connection top plate connected to the bottom of the connection rod 141, and a first vertical plate and a second vertical plate which are arranged on two sides of the connection top plate. The third wheel 143 is rotatably arranged between the first vertical plate and the second vertical plate.

In the present embodiment, the bottom end of the pull rod 13 is provided with a first protruding rod 131 and a second protruding rod 132 at an interval; the first protruding rod 131 is provided with a first through hole, and the second protruding rod 132 is provided with a second through hole corresponding to the first through hole; the top end of the connection rod 141 is provided with a third through hole corresponding to the first through hole; and first screws are arranged in the first through hole, the third through hole and the second through hole in a penetrating manner to cause the top end of the connection rod 141 to be rotatably connected with the bottom end of the pull rod 13.

Further, the wheel mechanism further includes a first fixed plate 144 arranged on the top surface of the extending plate 103, and a second fixed plate 145 arranged on a bottom surface of the extending plate 103. The extending plate 103 is provided with a first penetrating hole, and the first fixed plate 144 is provided with a second penetrating hole corresponding to the first penetrating hole; the second fixed plate 145 is provided with a third penetrating hole corresponding to the first penetrating hole; the connection rod 141 is arranged in the second penetrating hole, the first penetrating hole and the third penetrating hole in a penetrating manner. It should be understood that the extending plate 103 is clamped between the first fixed plate 144 and the second fixed plate 145.

In the present embodiment, two sides of the first fixed plate 144 respectively extend to be provided with a first fixed block 1441 and a second fixed block 1442, and the first fixed block 1441 and the second fixed block 1442 are arranged on the top surface of the extending plate 103 in a screw fastening manner. In the present embodiment, two sides of the second fixed plate 145 respectively extend to be provided with a third fixed block 1452 and a fourth fixed block 1453, and the third fixed block 1452 and the fourth fixed block 1453 are arranged on the top surface of the extending plate 103 in a screw fastening manner.

In the present embodiment, an end of the second fixed plate 145 facing the connection frame 142 is provided with a first accommodating blind hole communicating with the third penetrating hole. A buffer spring 1451 is arranged in the first accommodating blind hole, and the connection rod 141 is arranged in the buffer spring 1451 in a penetrating manner.

Preferably, an aperture of the first accommodating blind hole is greater than the aperture of the third penetrating hole. A depth of the first accommodating blind hole is less than a length of the buffer spring 1451 in a normal state, so that in the normal state, the buffer spring 1451 plays a role of buffering the mechanical platform scale.

Further, an end of the first fixed plate 144 facing the second fixed plate 145 is provided with a second accommodating blind hole communicating with the second penetrating hole; the second accommodating blind hole is provided with a bearing; and the connection rod 141 is arranged in an inner ring of the bearing in a penetrating manner.

Further, a first rotating rod 146 is rotatably arranged in the first vertical plate, and a second rotating rod 147 is rotatably arranged in the second vertical plate; and a friction strip 148 connected to the third wheel 143 and a pedal plate 149 located above the friction strip 148 are arranged between the first rotating rod 146 and the second rotating rod 147. It should be understood that the first rotating rod 146 and the second rotating rod 147 can be rotated manually. After being moved, the first rotating rod 146 and the second rotating rod 147 would not rotate by their weights, that is, the first rotating rod 146 and the second rotating rod 147 are tighter, and can be rotated by a certain force.

In conclusion, the novel mechanical platform scale disclosed by the present disclosure includes the platform scale body, wherein the first wheel and the second wheel are arranged at the top of the other side end of the platform scale body at an interval; the upright column arranged at one side end of the platform scale body; the adjustment mechanism arranged at the top end of the upright column; and the pull rod rotatably arranged in one side end of the platform scale body, wherein the top end of the pull rod is provided with a pull handle ring. One side end of the platform scale body extends to be provided with the extending plate, and the pull rod is rotatably arranged in the extending plate; the wheel mechanism is arranged in the extending plate; and the clamping mechanism used for clamping the pull rod in the upright column is arranged in the upright column. By the above mode, the mechanical platform scale disclosed by the present disclosure can be pulled by means of the pull rod to move, and is convenient to carry, so that the user experience is greatly enhanced.

The above descriptions are only the embodiments of the present disclosure, and are not intended to limit the scope of the present disclosure. Any equivalent structure or equivalent process transformation made by using the content of the description and drawings of the present disclosure and directly or indirectly applied to other related technical fields shall all be similarly included in the scope of patent protection of the present disclosure.

What is claimed is:

1. A novel mechanical platform scale, comprising a platform scale body, an upright column arranged at one side end of the platform scale body, and an adjustment mechanism arranged at the top end of the upright column, wherein a first wheel and a second wheel are arranged at the top of the other side end of the platform scale body at an interval; the novel mechanical platform scale is characterized by further comprising:
a pull rod rotatably arranged in one side end of the platform scale body, wherein the top end of the pull rod is provided with a pull handle ring;
wherein one side end of the platform scale body extends to be provided with an extending plate; the pull rod is rotatably arranged in the extending plate; a wheel mechanism is arranged in the extending plate; and a clamping mechanism used for clamping the pull rod in the vertical rod is arranged in the vertical rod.

2. The novel mechanical platform scale according to claim 1, wherein the adjustment mechanism is provided with a rectangularly planar top plate; the top plate is provided with a long-strip open slot disposed along a lengthwise direction, and the long-strip open slot is arranged on one side edge of the top plate to cause one side edge of the top plate to form a supporting rod used for supporting a weight.

3. The novel mechanical platform scale according to claim 1, wherein the platform scale body comprises a scale body supporting plate used for weighing and a supporting framework arranged outside the scale body supporting plate; the scale body supporting plate is planar, and a horizontal plane where the scale body supporting plate is located is the same as a horizontal plane where a top surface of the supporting framework is located.

4. The novel mechanical platform scale according to claim 1, wherein one side surface of the other side end of the upright column away from the platform scale body is provided, along the lengthwise direction, with an accommodating groove used for accommodating the pull rod.

5. The novel mechanical platform scale according to claim 1, wherein the clamping mechanism comprises a first fixed rod arranged on one side of the accommodating groove of the upright column, a second fixed rod arranged on the other side of the accommodating groove of the upright column, and a clamping rod with one end rotatably arranged in the first fixed rod; and a clamping slot used for accommodating the other end of the clamping rod is formed in the second fixed rod.

6. The novel mechanical platform scale according to claim 1, wherein the wheel mechanism comprises a connection rod arranged in the extending plate in a penetrating manner, a connection frame arranged at the bottom of the connection rod, and a third wheel rotatably arranged in the connection frame; and the top end of the connection rod is rotatably connected with the bottom end of the pull rod.

7. The novel mechanical platform scale according to claim 6, wherein the bottom end of the pull rod is provided with a first protruding rod and a second protruding rod at an interval; the first protruding rod is provided with a first through hole, and the second protruding rod is provided with a second through hole corresponding to the first through hole; the top end of the connection rod is provided with a third through hole corresponding to the first through hole; and first screws are arranged in the first through hole, the third through hole and the second through hole in a penetrating manner.

8. The novel mechanical platform scale according to claim 7, wherein the wheel mechanism further comprises a first fixed plate arranged on the top surface of the extending plate, and a second fixed plate arranged on a bottom surface of the extending plate, wherein the extending plate is provided with a first penetrating hole, and the first fixed plate is provided with a second penetrating hole corresponding to the first penetrating hole; the second fixed plate is provided with a third penetrating hole corresponding to the first penetrating hole; the connection rod is arranged in the second penetrating hole, the first penetrating hole and the third penetrating hole in a penetrating manner, and an end of the second fixed plate facing the connection frame is provided with a first accommodating blind hole communicating with the third penetrating hole, wherein a buffer spring is arranged in the first accommodating blind hole, and the connection rod is arranged in the buffer spring in a penetrating manner.

9. The novel mechanical platform scale according to claim 8, wherein an aperture of the first accommodating blind hole is greater than the aperture of the third penetrating hole, wherein a depth of the first accommodating blind hole is less than a length of the buffer spring in a normal state;
an end of the first fixed plate facing the second fixed plate is provided with a second accommodating blind hole communicating with the second penetrating hole; the second accommodating blind hole is provided with a bearing; and the connection rod is arranged in an inner ring of the bearing in a penetrating manner.

10. The novel mechanical platform scale according to claim 9, wherein two sides of the first fixed plate respectively extend to be provided with a first fixed block and a second fixed block, and the first fixed block and the second fixed block are arranged on the top surface of the extending plate in a screw fastening manner; two sides of the second fixed plate respectively extend to be provided with a third fixed block and a fourth fixed block, and the third fixed block and the fourth fixed block are arranged on the bottom surface of the extending plate in a screw fastening manner;
the connection frame comprises a connection top plate connected to the bottom of the connection rod, and a first vertical plate and a second vertical plate which are arranged on two sides of the connection top plate, wherein the third wheel is rotatably arranged between the first vertical plate and the second vertical plate;
a first rotating rod is rotatably arranged in the first vertical plate, and a second rotating rod is rotatably arranged in the second vertical plate; and a friction strip connected to the third wheel and a pedal plate located above the friction strip are arranged between the first rotating rod and the second rotating rod.
